(19) United States
(12) Patent Application Publication
(10) Pub. No.: US 2011/0191328 A1
(43) Pub. Date: Aug. 4, 2011

(54) SYSTEM AND METHOD FOR EXTRACTING REPRESENTATIVE MEDIA CONTENT FROM AN ONLINE DOCUMENT

(76) Inventors: Todd H. Vernon, Lafayette, CO (US); Emmanuel Puentes, Erie, CO (US); William H. Marcum, III, Louisville, CO (US); Daniel M. Jones, Niwot, CO (US); Randal W. Brumbaugh, Monrovia, CA (US)

(21) Appl. No.: 12/978,268

(22) Filed: Dec. 23, 2010

Related U.S. Application Data
(60) Provisional application No. 61/301,156, filed on Feb. 3, 2010.

(51) Int. Cl. G06F 17/30

(52) U.S. Cl. 707/723; 707/769; 707/E17.03

(57) ABSTRACT

A system and method for extracting representative media content from an online document is described. One illustrative embodiment identifies a content section in the electronic document; identifies one or more media items referenced or contained in the content section; identifies, among the one or more media items, at least one image that satisfies one or more predetermined criteria applied during an analysis pertaining to the one or more media items; selects, from among the at least one image that satisfies the one or more predetermined criteria, a particular image as the representative image; and stores information about the representative image.

### PRIORITY

The present application claims priority from commonly owned and assigned U.S. Provisional Patent Application No. 61/301,156, Attorney Docket No. OUTF-003/00US, filed Feb. 3, 2010, entitled System and Method for Extracting Representative Media Content from an Online Document, which is incorporated herein by reference in its entirety and for all purposes.

### FIELD OF THE INVENTION

The present invention relates generally to computerized techniques for characterizing media. In particular, but not by way of limitation, the present invention relates to identifying and extracting a representative media sample from an online document and processing the sample for inclusion in a synopsis.

### BACKGROUND OF THE INVENTION

Creating items containing text, images, and other media has been a typical human activity throughout history. For example, humans create documents that contain various media. Such documents can be used for example, for distributing information, teaching, archiving a method or recipe, generating historical logs or records, entertainment, expressing or arguing an opinion, legal agreements, recording thoughts or feelings, expression of creative ideas, or for artistic purposes.

Many documents contain only one type of media, while others contain multiple media types. It can be appreciated that a document is often more effective if it includes multiple media types. For example, an instructional book with both text and figures is more engaging to a wide audience of students than a book that includes only text. At one time typical documents comprised solely text and figures or images. References to other documents were through textual reference schemes such as footnotes or endnotes.

The proliferation and ubiquity of computers, massive storage capacity, and data networks has had a transformative effect on documents. As electronic means have been employed to create, store, share, and view documents, the quantity of documents available has increased, and more documents are created daily. In addition, documents can now include or reference a wide variety of media types and other documents, creating a web of online media and media hosts.

The development of computer networks, large storage capability, the Internet, and the World Wide Web have provided a means of creating and accessing linked documents and media online. Publishers on the Internet often make use of quick publishing sites known as weblogs or “blogs.” These rapid publication systems allow authors to post content including text, images, and other media on topics of interest. Online content can then be viewed by a wide audience. Information consumers then have many sources of information and opinions.

The proliferation of online media in combination with the ease of creating new content has created a number of challenges. For example, it can be difficult for information consumers to find particular publications and sources that are pertinent to their interests or information needs. In particular, it can be difficult for an information consumer to find references that are relevant when searching for an answer to a specific question or seeking documents related to an area of interest.

A conventional solution to this problem is web search engines, which employ a variety of techniques to allow users to search for online media content of interest. In application, a user forms a query and the web search engine returns links to online media that match the user query. Some representative examples of web search engines are GOOGLE, YAHOO, and BING. Some search engines are designed to return links to specific types of content, for example weblogs.

However, a problem with these conventional systems is that the user is often presented with many links to online media and can only pursue one or a few of them further. The user must choose which ones are worth further attention based on a brief description of the content. Conventional systems use a variety of techniques to generate this brief description, but these suffer from a number of limitations.

Many techniques have been attempted to automatically generate a summary of text, for example to use in presenting a brief description of content in a list of returned search results. However, this is a difficult problem. Conventional systems often yield results that are inaccurate, misleading, or not consistent for comparison with other results. For example, some conventional automatic approaches select a title, initial sentence, matching keyword phrase, or other text excerpt to represent media content. Other techniques include natural language understanding, keyword searches, and keyword proximity metrics, all of which are then processed by a computer application to try to “understand” and summarize the major theme or content of a media entity. The summary is then presented to a user or cached for later presentation. However, computerized automatic understanding techniques that are currently available are not able to consistently generate useful summaries of text and other media.

Although the summaries provided by conventional techniques can be of limited use in some cases, they often prove to be inadequate as the sole information about a site presented to a user who desires to select a site from a listing of many site options. Another approach to forming a representative synopsis is to select media content from the destination media. The old adage that a picture is worth a thousand words can be applied to searching online documents. This has a number of advantages.

One advantage is that the media content is chosen by the author. An author often selects and includes one or more media items as part of creating online content. For example, an author writing an online article about a particular automobile might include a photograph of the vehicle, a video recording of a road or track test, an audio recording of the engine sound, or a table comparing the vehicle to competitors. Since the media item is chosen and included explicitly by the author to illustrate a point of the article or to be representative, it has potential to be very helpful to a user in deciding if the article is relevant or interesting.

However, conventional systems encounter a number of challenges in automatically selecting a media component to represent online content. Many online media files contain multiple media items. Some of this content is not representative. For example, an image may be a formatting device such as a horizontal line, graphical advertising content, or a photograph of the author. In addition some files contain multiple images that might be useful, and one has to be selected to represent the content to the searcher. Thus conventional approaches such as choosing the first media item or randomly selecting from multiple media items in a document fail to consistently select representative media content.

Another set of challenges with conventional methods exists in retrieving the media content and preparing it for display to a search user. For example, in presenting representative images, each image is often condensed to a tiny “thumbnail” version for display so that multiple images can fit onto a display screen or printed page. Often a media file will not include the image itself, but instead includes a link to the image content stored elsewhere on a network-attached server. In some cases the link contains information about the image size while in others the information is only available in the image data itself. Conventional systems can suffer from difficulties in generating and displaying the representative thumbnail images.

It is thus apparent that there is a need in the art for an improved system and method for extracting representative media content from an online document.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a system and method for extracting representative media content from an online document. One illustrative embodiment is a system comprising at least one processor and a memory connected with the at least one processor, the memory containing a plurality of program instructions configured to cause the at least one processor to identify a content section in the electronic document; identify one or more media items referenced or contained in the content section; identify, among the one or more media items, at least one image that satisfies one or more predetermined criteria applied during an analysis pertaining to the one or more media items; select, from among the at least one image that satisfies the one or more predetermined criteria, a particular image as the representative image; and store information about the representative image.

Another illustrative embodiment is a computer-server-based method comprising identifying, via the computer server, a content section in the electronic document; identifying, via the computer server, one or more media items referenced or contained in the content section; identifying, via the computer server among the one or more media items, at least one image that satisfies one or more predetermined criteria applied during an analysis pertaining to the one or more media items; selecting, via the computer server from among the at least one image that satisfies the one or more predetermined criteria, a particular image as the representative image; and storing, via the computer server, information about the representative image.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1A is a schematic depiction of an environment in which the features and descriptions herein can be practiced in accordance with various illustrative embodiments of the invention;

FIG. 1B is a functional block diagram of a computer equipped with a web crawler application in accordance with an illustrative embodiment of the invention;

FIG. 1C is a functional block diagram of a computer equipped with an index server application in accordance with an illustrative embodiment of the invention;

FIG. 2 illustrates components involved in rendering a source document into a display document in accordance with the prior art;

FIG. 3A depicts the components of a conventional indexing service in accordance with the prior art;

FIG. 3B depicts the components of an indexing service in accordance with an illustrative embodiment of the invention;

FIG. 4A is a flow chart of a method for identifying a representative media item in accordance with an illustrative embodiment of the invention;

FIGS. 4B and 4C are flow charts of specific processing techniques in accordance with illustrative embodiments of the invention;

FIG. 5 is a flow chart of a method for testing a media object in accordance with an illustrative embodiment of the invention;

FIG. 6 schematically depicts a displayed page corresponding to a source document that is to be indexed in accordance with an illustrative embodiment of the invention;

FIG. 7 schematically depicts a web page search result in accordance with an illustrative embodiment of the invention;

FIG. 8A is a schematic depiction of the functional elements involved in responding to a search query in accordance with an illustrative embodiment of the invention; and

FIG. 8B is a schematic depiction of the functional elements involved in responding to a search query in accordance with another illustrative embodiment of the invention.

### DETAILED DESCRIPTION

In the descriptions and drawings that follow, a small number of components and connections are sometimes described or depicted to facilitate explanation and illustration. The number of components depicted herein is merely illustrative. It should be understood that these examples do not limit the ultimate capability of the invention, including quantity of components, number of instances or interconnections that are possible. The embodiments disclosed below are not intended to be exhaustive or limit the invention to the precise form disclosed in the following detailed description. Rather, the embodiments are chosen and described so that others skilled in the art may utilize its teachings.

The detailed descriptions that follow include algorithms and symbolic representations of operations on data within a computer memory, wherein the data is stored and retrieved by means of manipulation of physical qualities such as electrical or magnetic properties of materials. The computer data often correspond to abstract human conceptual items such as documents, files, records, and data. Conceptual items are represented in a computer memory by use of various encoding schemes. These descriptions and representations are an abstraction used by those skilled in the data processing arts to most effectively communicate aspects of their work to others skilled in the art.

An algorithm is conventionally understood to be a predefined sequence of processes and decisions leading to a desired outcome. Executing these processes and producing the outcome is a consequence of manipulation of physical entities. Usually, though not necessarily, these entities are expressed as electrical or magnetic signals and states that are stored, transferred, combined, compared, or otherwise manipulated. It is convenient at times to refer to these states and signals at a higher level of abstractions, using terms such as bits, values, symbols, characters, display data, terms, numbers, or the like. It should be borne in mind, however, that all of these and similar terms are associated with the corresponding physical quantities and the abstractions used herein map to these quantities.

Terms commonly associated with mental or physical operations performed by a human operator are often employed to explain the manipulations performed by computing machinery. Examples of such terms include adding, multiplying, fetching, storing, reading, writing, or deciding. However, the use of these terms is descriptive only and does not imply that a human operator is necessary or desirable. In fact, a human operator is undesirable in most cases, and the operations described which form part of the embodiments and descriptions herein are machine operations. Useful machines for performing such operations include general-purpose digital computers, special-purpose computers, or other similar devices.

In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general-purpose computer as selectively activated or configured by a computer program stored in the computer. The apparatus may also comprise a “cluster,” wherein multiple computers with an interconnecting data network are configured to act in concert for the intended purpose.

It should be appreciated that the methods and operations described herein comprise multiple complex functions that interact with one another and outside entities. The operation or function of these methods is usually not immediately apparent from a software listing. Nor is it easy to determine how a program works through observation of the readily apparent manifestations or artifacts of its operation. Most of the operations carried out by a computer in response to a program are not visible to an observer since only a relatively few of the operations in execution of a program typically produce observable output.

The term “windows” and associated terms such as “windowing environment” or “running in windows” defined above refer to a type of computer user interface, exemplified by the several windowing systems available from Microsoft Corporation of Redmond, Wash. Other windows computer interfaces are available, for example from Apple Computers Incorporated of Cupertino, Calif. and as components of the LINUX operating environment. In particular it should be understood that the use of these terms in the descriptions herein does not imply a limitation to any particular computing environment or operating system.

The term “real-time” (also “realtime”) or “near real-time” means a system design approach that uses timing as a primary design objective. In particular, a real-time system completes one or more operations within a time interval that meets predetermined criteria. The term can also be used to refer to an operation performed, for example an “update in real-time.” The time interval criteria may be a specific amount of time, or may be defined in contrast to another non-real-time system, sometimes referred to as “batch” or “offline” system. It can be appreciated that the time interval is determined by requirements that vary among systems. For example, a high-performance aircraft real-time control system may be required to respond in microseconds, while for a real-time reservoir level regulator update intervals of hours may be acceptable. In interactions with a human user, a system providing “real-time response” means a user receives a response to an input quickly enough to allow interactive or “live” use of the system without an unacceptable delay (typically, a user might accept a delay of less than a second for transactions that are expected to be immediate, while a user might accept a delay of a minute for a complicated transaction requiring interaction with a remote site).

Several terms have special meanings in the descriptions that follow. The terms “document,” “page,” web page,” “online document,” or “electronic document” all refer to an electronic form of a published work, where such work may be the product of a human author or generated by a machine or other automated process. These documents are stored and manipulated in digital form, that is as a series of encoded media and data structures that are able to be stored and transmitted in forms compatible with digital computers and computer networks.

As used herein, the term “image” refers to a media element included in a document that communicates to a viewer primarily by visual impression rather than by reading. Examples of an image, without limitation, include a color photograph, a black and white photograph, a half-tone picture, a line drawing, a chart, a table, a sketch, a presentation slide, a data graph, and tabular data. An image is sometimes composed partially or entirely of text, words, or characters. An image can be still or moving. A “moving image” is an ordered sequence of still images. A moving image is sometimes called an “animation” or “movie.”

As used herein, the term “web” refers to an interlinked set of documents and the interconnections, protocols, software applications, and machinery that operates to make those documents available within the web. Some of the documents in a web contain links referring to other documents in the web. Documents on a web are typically viewed using a “web browser” that interacts with a user by retrieving web documents, rendering those documents, and following links. The links from one web document to another web document or from one location in a web document to another location in that same web document are also referred to as “web links” or “hyperlinks.” Applications or machinery that respond to requests for web documents are known as “web servers.”

One instance of a web known to those skilled in the art is referred to as the “World Wide Web,” which uses the Internet as a substratum. The descriptions herein can apply to the World Wide Web. However, it should be understood that the principles of the instant invention apply to webs in general and are not limited to the World Wide Web nor to any particular instance of a web. Neither are the principles of the invention limited to webs based on any particular network or collection of networks. For example, an organization may have a document web available on a local intranet or a private network.

It is important in dealing with electronic documents to distinguish between the “source document” and the “display document.” A source document typically contains information for producing a display document, where the display document is what a user sees on a computer screen or in a hardcopy printed form of the document. The display document is analogous to printed material in that it is designed to be viewed by a user. By contrast, the source document corresponding to a display document provides information on how to generate the display document. It may contain for example, display formatting directives, markup, annotation, media content, links to external media content, and metadata providing information about the document. An important consideration is that a source document does not necessarily contain all the media content that will be displayed when the document is rendered. Instead, the source document can include links or hyperlinks that describe where the content can be found and retrieved when the document is rendered.

In some instances a source document includes executable software, often termed “code.” For example, many browsers are capable of executing functions provided in the JAVA or JAVASCRIPT languages as software code. JAVA is a programming language and environment available under license from Sun Microsystems of Santa Clara, Calif. JAVASCRIPT is a scripting language based on the ECMAscript standard. Although the two languages have similar names, they are distinct and differ in many aspects of features and utility. There are other languages available that operate to provide functionality in a browser or rendering process. These languages allow logic and processing directions to be specified that are executed in a client application such as a browser at the time the document is rendered. Those familiar with the art will appreciate the benefits and results that can be achieved by including executable code in a source document. For example, code to rescale an image to fit into an area of given dimensions is sometimes included in a source document.

Conversion from the source document to the display document is a process usually termed “rendering.” The rendering operation is a primary function of browsers and associated media decoders. Rendering may include decoding media, fetching data references from links in the source document, formatting, applying style rules, and other processes to fetch, decode and display elements called for or included in the source document. Rendering may also include execution of software code that is included in the source document.

Many formats for source documents have been defined as formal or de facto standards. Some exemplary formats are The International Standards Organization (ISO) Standardized Generalized Markup Language (SGML), Hyper-Text Markup Language (HTML), Extensible Markup Language (XML), and Rich Text Format (RTF). The Microsoft Corporation of Redmond Wash. has defined a number of source document formats for use with computer applications marketed by the company. The Microsoft formats are widely used and include file storage and sharing formats for the company's Word, EXCEL, VISIO, and POWERPOINT products. The source document formats listed herein are by way of example only and should not be taken as limiting or complete. The features and descriptions herein are in no way dependent on use of any specific source document type or format. Rather, the features and descriptions herein are applicable to any source document format, whether the format exists at present or is created in the future.

A source document can include one or more media elements. A media element may be part of the source document, wherein the media content is encoded and included as part of the source document material. A media element may also be included in a source document by reference, wherein the source document contains a link, address, location, or pointer that describes the linked media content specifically enough to allow a renderer to obtain the content. Such links can include information about the linked content. For example, an image link may include information about the dimensions of the image. A common way to include a link is defined in the HTML source document format, where the link comprises a Uniform Resource Identifier (URI), Uniform Resource Locator (URL), or Uniform Resource Name (URN).

It should be appreciated that the features and descriptions herein are not limited to any specific media format or encoding scheme, nor are they limited to a set of formats or encoding schemes. By way of example, some media encoding schemes representative of those compatible with the features and descriptions herein are listed. For an image or picture media, exemplary encoding schemes include Tagged Image File Format (TIFF), Joint Photographic Experts Group (JPEG), Apple Computer PICT format, Graphics Interchange Format (GIF), Portable Network Graphics (PNG). Those familiar with the art will appreciate that there are many encoding schemes employed with various attributes such as vector or bitmapped graphics representation, compression, or inclusion of other data or metadata.

Similarly video or motion pictures can be encoded and decoded by a number of schemes. Exemplary schemes include those defined by the publications of the Moving Picture Experts Group of the ISO (MPEG), Apple Computer Corporation's QUICKTIME media format, Microsoft Corporation's WINDOWS MEDIA Player (WMP), or the REALAUDIO, REALVIDEO, and REALMEDIA formats from RealNetworks, Inc. of Seattle Wash. These formats can include other media types such as synchronized audio or presentation slides. Audio media content may be encoded by a number of schemes. Another notable source document and media format is the Portable Document Format (PDF) from Adobe Systems of San Jose, Calif.

Text is often encoded using the standard American Standard Code for Information Interchange (ASCII or US-ASCII), which defines a numerical representation of common characters found in English and other languages based on a Latin alphabet. Another frequently used representation is Unicode which defines encoding for characters used in many written languages. Further encoding of text media content can include information on font, character size, spacing, line breaks, and other details of displaying text on a page. It should be appreciated that the features and descriptions herein are in no way limited to any specific language or text encoding scheme.

It should also be appreciated that the features and descriptions herein can be used with other media types and rendering apparatus, whether presently known or conceived in the future. For example, an encoding scheme for aroma, touch, or stimulation of other human senses is consistent with the principles of the invention.

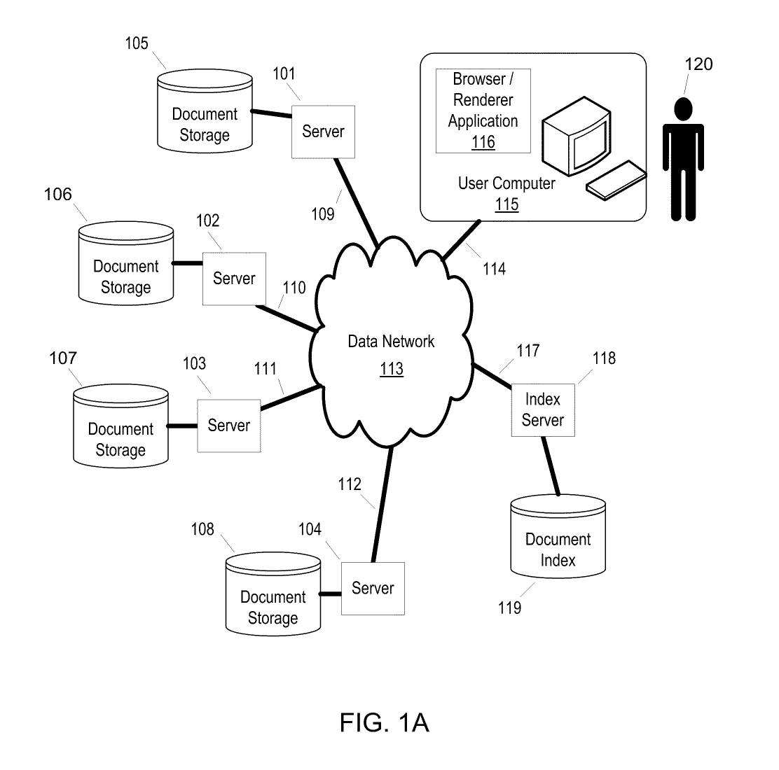

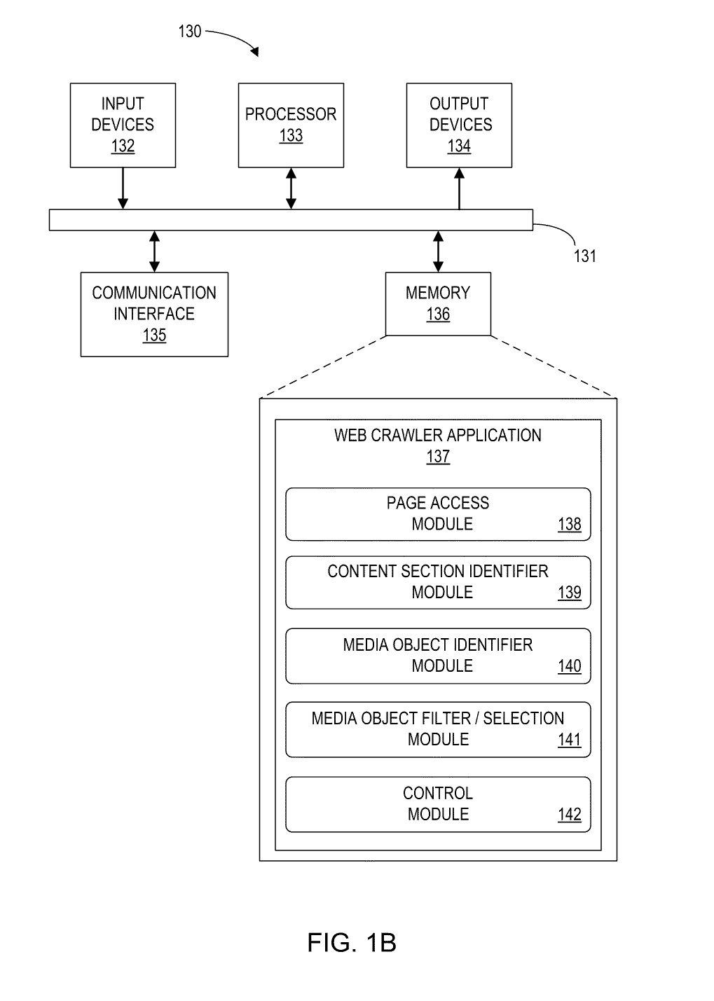

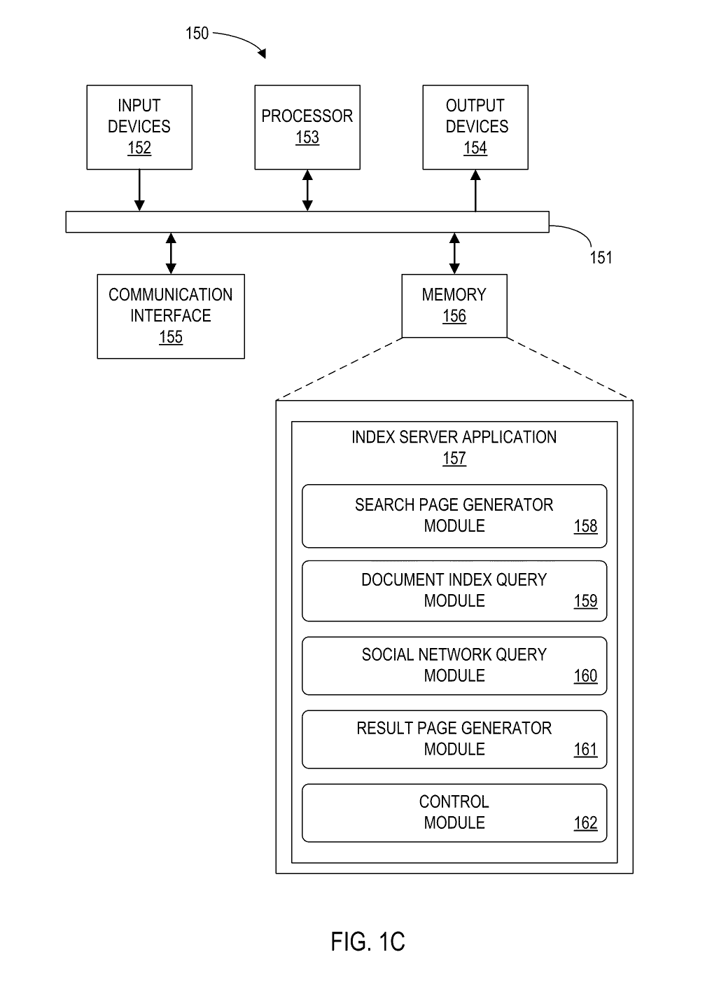

Referring now to the drawings, where like or similar elements are designated with identical reference numerals throughout the several views, FIG. 1A is a schematic depiction of an environment in which the features and descriptions herein can be practiced in accordance with various illustrative embodiments of the invention. Servers 101, 102, 103, and 104 are content servers configured to respond to requests for content and deliver corresponding content via the associated network connection. Server 101 connects to data network 113 through network connection 109 and provides content stored in document storage 105. Server 102 connects to data network 113 through network connection 110, providing content from document storage 106. Server 103 connects to data network 113 through network connection 111 and provides content from document storage 107. Server 104 connects to data network 113 through network connection 112 and provides content from document storage 108.

It should be appreciated that the servers 101, 102, 103, and 104 are shown as single units for illustration. Each server 101-104 may in practice be multiple units, clusters, or networks that appear to other devices on the network 113 as a single node. Similarly the document storage facilities 105, 106, 107, and 108 can be databases, storage clusters, or multiple storage devices.

It should also be appreciated that although only four servers 101, 102, 103, and 104 are illustrated as connected to data network 113, any number of servers can be connected to data network 113 without departing from the spirit of the descriptions herein. Data network 113 is illustrated as a cloud with several representative connections 109-112, 114, and 117 to emphasize that many different networks and connection schemes can be used as a basis for various exemplary embodiments of the invention.

In one example, data network 113 is the Internet and servers 101-104 operate to provide documents to a web. In an exemplary system, the web is the World Wide Web. Thousands of servers connect to the World Wide Web. In one example, servers 101, 102, 103, and 104 are web servers, and the documents provided are HTML, Extensible Hypertext Markup Language (XHTML), and media files. In one example, at least some of the documents provided by servers 101-104 are weblogs or blogs and associated media content.

Referring again to FIG. 1A, user 120 desires to view display documents based on source documents stored in the document storage repositories 105-108. Accordingly, user 120 causes user computer 115 to issue a request using network connection 114 to data network 113. Such a request can be initiated, for example, by entering a URI or other document location address. In one embodiment, the request includes identifying information indicating the specific server that can provide the document. For example, the request can be entered into a browser in alphanumeric form. Alternatively, the document request may be initiated by user 120 by activating a hyperlink. A document can be automatically requested by an application program executing on computer 115 on behalf of user 120.

The request is routed via data network 113 to an appropriate server. For example, if the desired source document is stored on document storage 106, server 102 will respond to the request by providing a copy of the desired source document. The copy of the desired document is transmitted by server 102 via network connections 110 and 114 and data network 113 to user computer 115. The copy of the source document is received and converted to a display document by renderer application 116. The display document is then available for user 120 to use, for example to view on a display or print in hardcopy form. In one embodiment renderer application 116 is a web browser.

It is often the case that user 120 does not know which of the servers 101-104 is capable of providing the desired document. It is also often the case that user 120 does not desire a specific document but instead desires to locate one or more documents that meet a set of search criteria. In any of these situations user 120 can use an appropriate application to direct computer 115 to connect to index server 118 using network connections 117 and 114 and data network 113. Index server 118 is configured to maintain an index of the documents accessible via network servers and to continuously update the index to reflect changes, additions, or deletions in the documents contained in storage 105-108. Index server 118 maintains this index in document index 119. Thus index server 118 provides a document search service to user 120, wherein the document search service provides a list of documents on servers 105-108 that meet search criteria provided by user 120.

Index server 118 can be a component of a web search engine. Examples of common web search engines are GOOGLE, BING, and YAHOO. Index server 118 may be configured to perform searches based on keywords supplied by user 120. Index server 118 may also be a component of a service to locate documents based on a social trust network. Such a service is provided by Lijit Inc. of Boulder, Colo.

As described, index server 118 provides a list of documents, wherein the documents in the list are identified by server 118 from a search of the index 119 using information from user 120 in conjunction with various search strategies. A search may produce hundreds or thousands of documents. User 120 then decides if any of the documents in the list are truly of interest. User 120 may decide to revise his search if the documents or document list are not satisfactory or sufficient. To facilitate the decision of user 120, index server 118 returns additional information about each document in the list and this information is displayed to user 120.

In many conventional systems, the additional information about each document includes a summary of the content of the document. Examples of content summary items that are useful include one or more of: a title, an excerpt, key words, and key phrases. In some conventional systems, words in the document that match user-supplied search terms are included in the document summary.

In one embodiment according to the present invention, the additional information presented for each document includes a media excerpt taken from the corresponding document. A media excerpt is a media item derived from or comprising a selected part of a document. For example, a media excerpt can include a sequence of words, a phrase, a title, an image, or a frame from a video.

In one embodiment, the summary information presented about a document includes a media item derived from a media excerpt taken from the corresponding document. For example, when a document contains an image, the information presented by index server 118 includes a reduced representation of the image in the document. Thus the media excerpt in this embodiment is an image extracted from the document and the reduced representation of the image is derived from the image found or referenced in the document. Such a reduced representation may be smaller, have lower resolution, or have a reduced number of colors. Providing a reduced representation has a number of advantages. A reduced representation can be displayed in a small area, allowing multiple document descriptions to be displayed simultaneously. Such a reduced image is often called a “thumbnail” image. A reduced representation uses less storage and will transfer more quickly across data network connections.

In one embodiment, the location of the media data is stored, thereby avoiding the storage of media data. Examples of media location data include a URL, a network address, a pointer, a server name, a protocol for retrieval, and a filename. In one embodiment, metadata describing the media is stored in association with the location of the media. In one embodiment, the media is an image and the metadata includes the dimensions of the image at the location.

In one embodiment, the location and describing metadata are returned as a component of a search result, serving as a representative media item. A client browser then uses the location and metadata to produce an image suitable for presentation. Often it is desirable to display a smaller version of an image that retains the aspect ratio of the original image. In one embodiment, the metadata includes the dimensions of the source image.

In one embodiment, the reduced representation of the media excerpt is pre-computed and stored in document index 119. In an alternative embodiment, the reduced representation of the media excerpt is computed by index server 118 at the time the document list is returned in response to a search request. In one embodiment, the reduced representation is partially computed, and the intermediate result is stored in index 119.

In an alternative embodiment, the original size of the representative image is stored in index 119, and the reduced representation of the media excerpt is computed at the time the document list is returned in response to a search request.

FIG. 1B is a functional block diagram of a computer 130 equipped with a web crawler application 137 in accordance with an illustrative embodiment of the invention. Computer 130 may be any computing device capable of executing web crawler application 137. For example, computer 130 may be, without limitation, a personal computer, a server, a workstation, a laptop computer, or a notebook computer.

In FIG. 1B, processor 133 communicates over data bus 131 with input devices 132, output devices 134, communication interface 135, and memory 136. Though FIG. 1B shows only a single processor, multiple processors or a multi-core processor may be present in some embodiments.

Input devices 132 include, for example, a keyboard, a mouse or other pointing device, or other devices used to input data or commands to computer 130 to control its operation.

In the illustrative embodiment shown in FIG. 1B, communications interface 135 is one or more instances of a Network Interface Card (NIC) that implements a standard such as IEEE 802.3 (often referred to as “Ethernet”) or IEEE 802.11 (a set of wireless standards). In general, communication interface 135 permits computer 130 to communicate with other computers via one or more networks. In particular, communications interface 135 permits computer 130 to act as a client in a web. In one embodiment, communications interface 135 permits computer 130 to exchange messages with other computers using the Internet. In one embodiment, communications interface 135 permits computer 130 to participate in the World Wide Web.

Memory 136 may include, without limitation, random access memory (RAM), read-only memory (ROM), FLASH memory, magnetic storage (e.g. a disk drive), optical storage, or a combination of these, depending on the particular embodiment. In FIG. 1B, memory 136 includes web crawler application 137. Herein, “web crawler” refers to a computer application or automated script that automatically and systematically browses a web to create an index of documents available on the web.

Memory 136 may also include means for reliable storage of large quantities of data. Such means may include one or more instances of a database, hierarchical or tiered storage systems including a cache, redundant arrays of disks such as RAID systems, flat files, network attached storage (NAS) devices, distributed hash tables, or striped disk arrays.

Though not shown in FIG. 1B, computer 130 includes an operating system, which can be any of a variety of different types, including, without limitation, the MICROSOFT WINDOWS operating system, the LINUX operating system, and the MAC OS operating system, depending on the particular embodiment.

In the illustrative embodiment of FIG. 1B, web crawler application 137 includes the following functional modules: page access module 138, content section identifier module 139, media object identifier module 140, media object filter and selection module 141, and control module 142. The division of web crawler application 137 into the particular functional modules shown in FIG. 1B is merely illustrative. In other embodiments, the functionality of these modules may be subdivided or combined in ways other than that indicated in FIG. 1B, and the names of the various functional modules may also differ in other embodiments.

In one illustrative embodiment, web crawler 137 and its functional modules shown in FIG. 1B are implemented as software that is executed by processor 133. Such software may be stored, prior to being loaded into RAM for execution by processor 133, on any suitable computer-readable storage medium such as a hard disk, an optical disk drive, or other non-volatile storage device. In general, the functionality of web crawler 137 may be implemented as hardware combined with software and/or firmware.

FIG. 1C is a functional block diagram of a computer 150 equipped with an index server application 157 in accordance with an illustrative embodiment of the invention. Computer 150 may be any computing device capable of executing index server application 157. For example, computer 150 may be, without limitation, a personal computer, a server, a workstation, a laptop computer, or a notebook computer.

In FIG. 1C, processor 153 communicates over data bus 151 with input devices 152, output devices 154, communication interface 155, and memory 156. Though FIG. 1C shows only a single processor, multiple processors or a multi-core processor may be present in some embodiments.

Input devices 152 include, for example, a keyboard, a mouse or other pointing device, or other devices used to input data or commands to computer 150 to control its operation.

In the illustrative embodiment shown in FIG. 1C, communications interface 155 is one or more instances of a Network Interface Card (NIC) that implements a standard such as IEEE 802.3 (often referred to as “Ethernet”) or IEEE 802.11 (a set of wireless standards). In general, communication interface 155 permits computer 150 to communicate with other computers via one or more networks. In particular, communications interface 155 permits computer 150 to act as a server in a web. In one embodiment, communications interface 155 permits computer 150 to exchange messages with other computers using the Internet. In one embodiment, communications interface 155 permits computer 150 to participate in the World Wide Web.

Memory 156 may include, without limitation, random access memory (RAM), read-only memory (ROM), FLASH memory, magnetic storage (e.g. a disk drive), optical storage, or a combination of these, depending on the particular embodiment. In FIG. 1C, memory 156 includes index server application 157. Herein, “index server” refers to a computer application that responds to structured search queries from other web clients. The response includes an ordered list of documents in an index that match the query and other criteria.

Memory 156 may also include means for reliable storage of large quantities of data. Such means may include one or more instances of a database, hierarchical or tiered storage systems including a cache, redundant arrays of disks such as RAID systems, flat files, network attached storage (NAS) devices, distributed hash tables, or striped disk arrays.

Though not shown in FIG. 1C, computer 150 includes an operating system, which can be any of a variety of different types, including, without limitation, MICROSOFT WINDOWS, LINUX, and MAC OS, depending on the particular embodiment.

In the illustrative embodiment of FIG. 1C, index server application 157 includes the following functional modules: search page generator module 158, document index query module 159, social network query module 160, result page generator module 161, and control module 162. The division of index server application 157 into the particular functional modules shown in FIG. 1C is merely illustrative. In other embodiments, the functionality of these modules may be subdivided or combined in ways other than that indicated in FIG. 1C, and the names of the various functional modules may also differ in other embodiments.

In one illustrative embodiment, index server 157 and its functional modules shown in FIG. 1C are implemented as software that is executed by processor 153. Such software may be stored, prior to being loaded into RAM for execution by processor 153, on any suitable computer-readable storage medium such as a hard disk, an optical disk drive, or other non-volatile storage device. In general, the functionality of index server application 157 may be implemented as hardware combined with software and/or firmware.

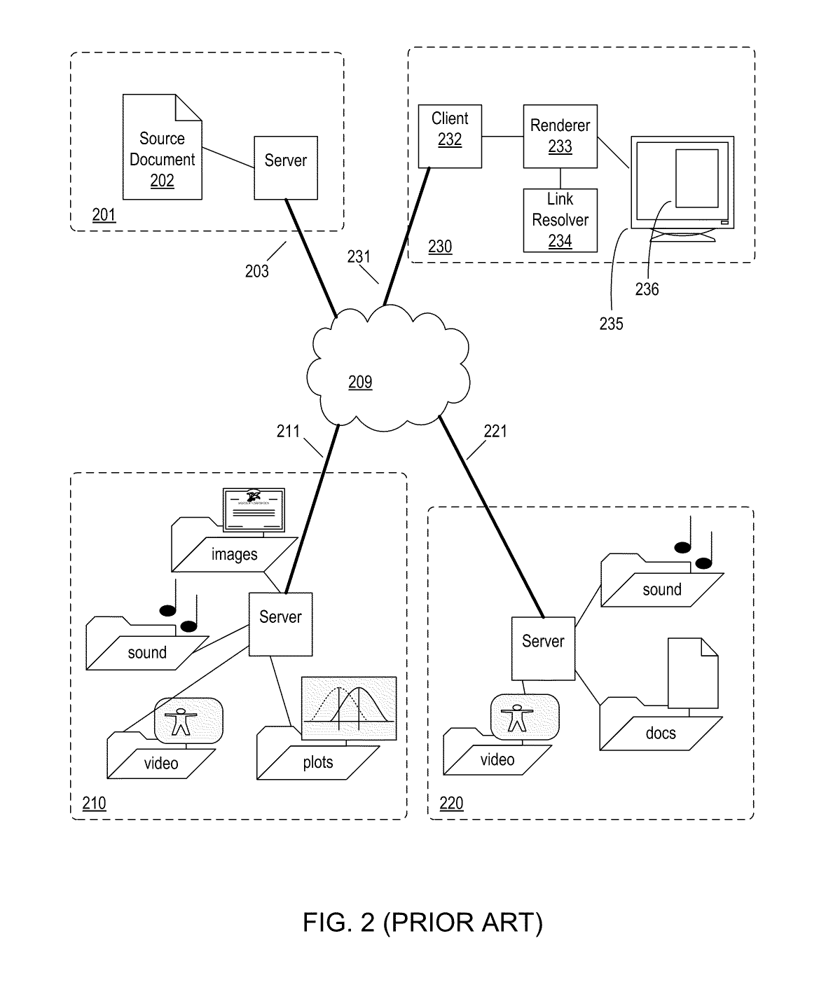

Referring now to FIG. 2, the components involved in rendering a source document 202 into a display document 236 in accordance with the prior art are described. Server 201 provides a copy of source document 202 to client 232, which is an application program executing on computer 230. The copy of the source document is delivered using network links 203 and 231 connecting to data network 209. Often the process of supplying a copy of the source document is referred to simply as moving the document, but it can be appreciated that the document is not actually moved in that the process of delivery does not remove the original.

Client application 232 provides the received source document to rendering application 233. Rendering application 233, also an application executing on computer 230, translates the local copy of source document 202 into a displayed representation 236 on display unit 235. Often the source document 202 will not include all of the content required to generate the display document 236 but instead will include directives for retrieving some of the content elsewhere. This is very common with media content. For example, an image in display document 236 may be provided by another server on the network and this is indicated in source document 202 by an encoding scheme specifying the location and often the protocol for obtaining the image. If source document 202 contains links to external media, link resolver 234 retrieves the media via network 209. With reference to FIG. 2, link resolver 234 on computer 230 uses network connection 231 to access data network 209. Data network 209 is in turn connected to servers 210 and 220 via network connections 211 and 221. The two servers 210 and 220 are shown as representative only. In practice any number of servers can be connected to supply media or content.

In one example, data network 209 is the Internet and source document 202 is an XHTML document. In one example, source document 202 is web content authored by a publisher in the form of an online article, review, or opinion.

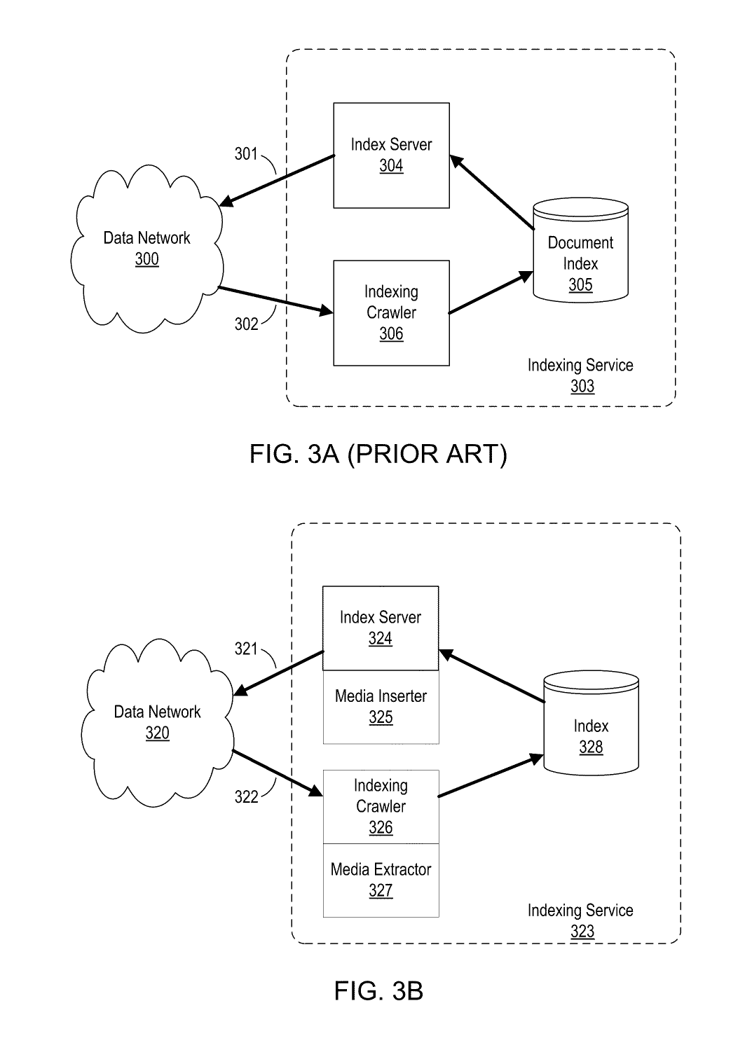

FIG. 3A depicts the components of a conventional indexing service in accordance with the prior art and will be used to describe the indexing of documents in a conventional system. Data network 300 connects to both document providers or servers, and also to document consumers. Indexing service 303 is shown as a single unit for the functional descriptions herein but often physically comprises multiple computers, interfaces, internal networks, and arrays of storage devices.

It can be appreciated that the indexing service 303 contains two distinct processes, indexing crawler 306 and index server 304. Both share data with the document index 305. Index server 304 connects to network 300 through link 301. Indexing crawler 306 connects to network 300 through link 302.

Indexing crawler 306 scans and processes documents available from servers and document providers connected to data network 300. In some cases, indexing crawler 306 processes a selected subset of all items available via network 300. In another implementation, indexing crawler 306 only searches for a subset of documents or documents meeting specified criteria. Indexing crawler 306 records data descriptive of each processed document into index 305.

It should be appreciated that the set of servers connected and the documents available change over time. As time passes, new documents become available and older documents are deleted. Also the contents of each document may or may not change with the passage of time. Thus, the process of maintaining an accurate index 305 is an ongoing one.

In general, at any point in time index 305 contains an approximate representation of the documents available from network 300. Thus, it is advantageous for crawler 306 to work in a batch mode, continuously looking for new documents and revisiting old ones to update index 305.

By contrast, index server 304 functions in a real time mode, providing results to queries as rapidly as possible. Server 304 receives a query from a document seeker and then searches index 305 for matching documents. Server 304 returns the list of matching documents. An important additional function of server 304 is ordering the list of documents returned to the document seeker. Another function of server 304 is formatting the results for display to the document seeker.

Indexing service 303 can be configured to provide indexing and document search according to different document search schemes. It is typical to have many different instances of service 303 connected to a given network 300.

In the conventional indexing service depicted in FIG. 3A, network 300 is a document web. For example, the depicted web can be the Internet-hosted World Wide Web. Indexing service 303 may be a search engine such as GOOGLE, BING, or YAHOO, using words as search queries. Index server 304 generates an HTML document representing a formatted result list, where the result list contains a link and descriptive summary for each document in index 305 matching a search query. In some implementations, the result list is limited to a predetermined size or number of list elements.

The service 303 may also be a search engine based on personal trust described in an informer network, for example the service of Lijit, Inc. Further details regarding such an informer network can be found in U.S. patent application Ser. No. 11/471,200, filed on Jun. 20, 2006, a copy of which is included herein in the Appendix.

Refer next to FIG. 3B, which depicts the components of an embodiment of an indexing service in accordance with an illustrative embodiment of the invention. In FIG. 3B, data network 320 connects to both document providers or servers, and also to document consumers. Indexing service 323 contains indexing crawler 326, and index server 324. Both share data with document index 328. Index server 324 connects to network 320 through link 321. Index crawler 326 connects to network 320 through link 322.

Although link 321 is depicted as carrying outgoing data and link 322 is depicted as carrying incoming data, in some embodiments the two links operate on one interface and physical data connection, wherein the connections provide bi-directional data flow.

Indexing service 323 works in conjunction with media extractor 327. In one embodiment media extractor 327 works in concert with crawler 326 when building index 328 from documents available from network 320. Media extractor 327 examines each source document to identify a representative media component in the source document. The identified media component is then included in document index 328 and returned by server 324 when a search matches the source document.

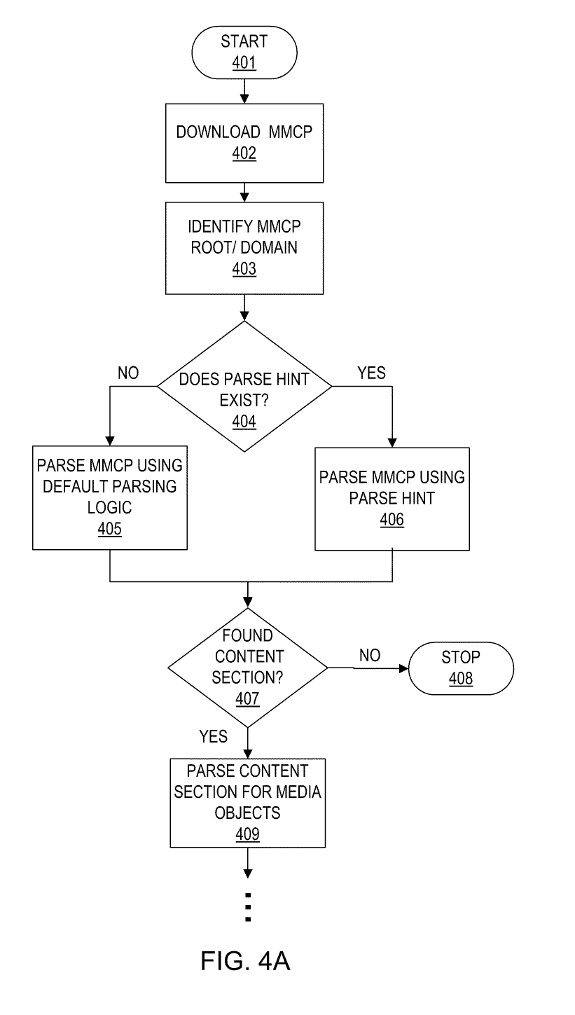

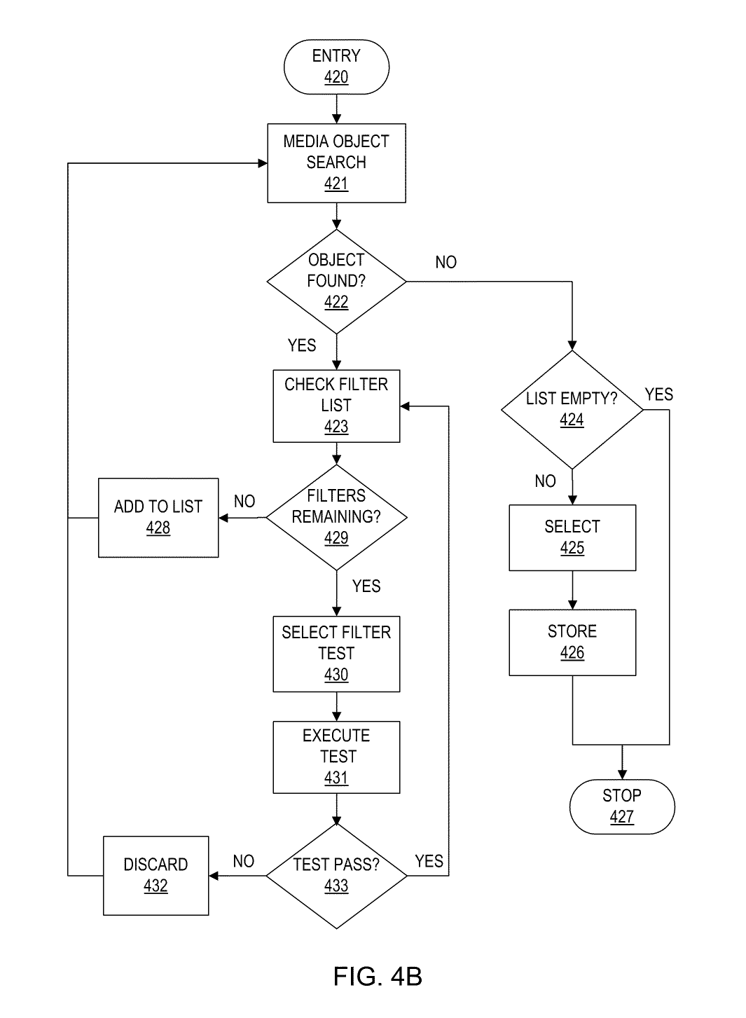

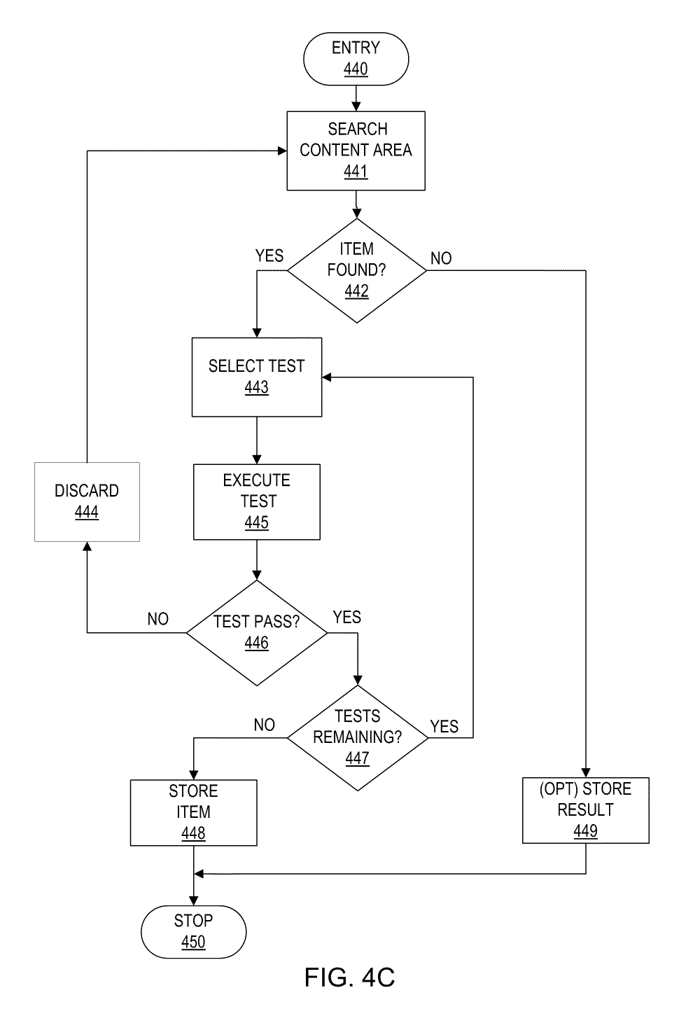

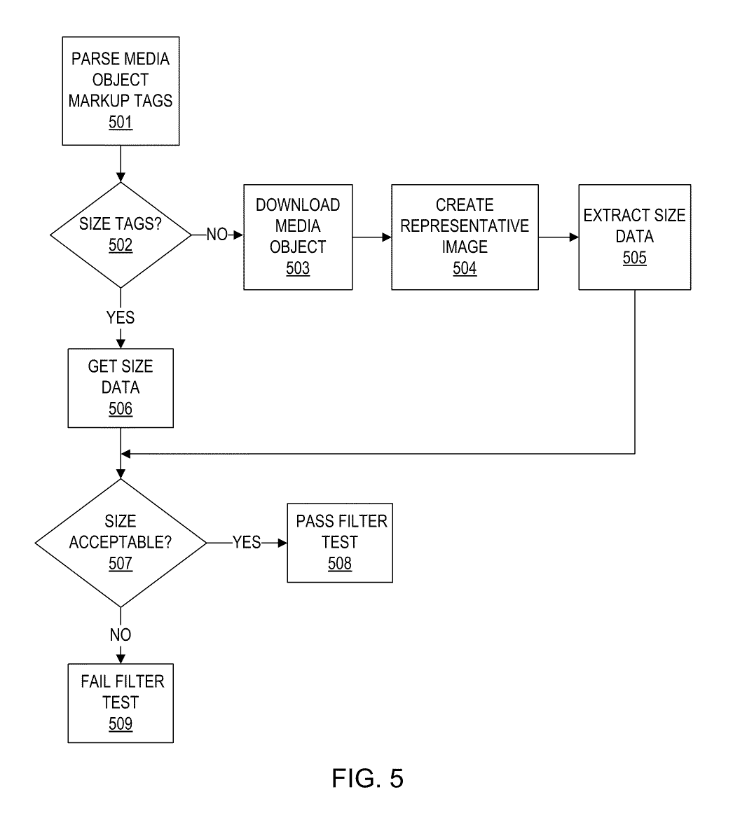

Further details of configuration, operation, and machine implementation of embodiments of indexing crawler 326 with media extractor 327 are provided herein in FIG. 1B, FIG. 4A, FIG. 4B, FIG. 4C, FIG. 5, and the accompanying textual descriptions. In particular, the machine-attached web crawler application 137 (FIG. 1B) corresponds, in one embodiment, to the combination of indexing crawler 326 with media extractor 327.

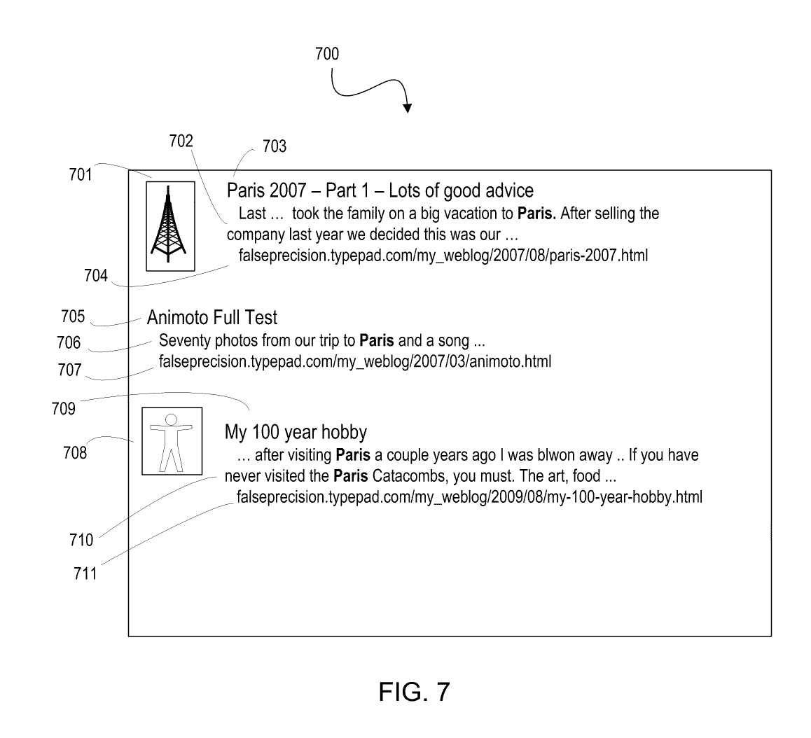

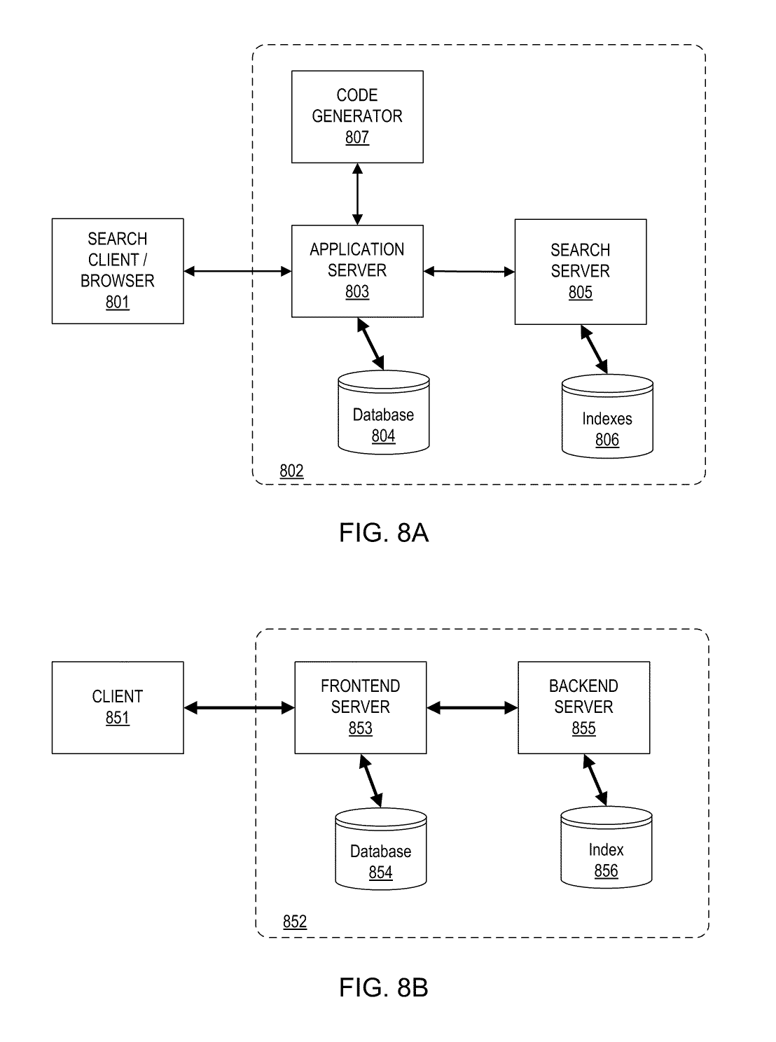

Further details of configuration, operation, and machine implementation of embodiments of index server 324 with media inserter 325 are provided herein in FIG. 1C, FIG. 7, FIG. 8A, FIG. 8B, and the accompanying textual descriptions. In particular, the machine-attached index server application 157 (FIG. 1C) corresponds, in one embodiment, to the combination of index server 324 with media inserter 325.

In one embodiment, the media data is included in index 328. In another embodiment, a pointer to the server where the media content is hosted is stored in index 328. In an alternative embodiment, the media content is processed to produce a representative image based on the media content and the representative image is stored in the index 328. In an alternative embodiment, a representative image is stored separately, and a link referring to the representative image location is stored in index 328.

In one embodiment, the processing to produce the representative image includes producing a smaller thumbnail image such that the image has smaller dimensions than the original image but retains the same ratio of width to height. The ratio of width to height is often referred to as “aspect ratio.” In one embodiment if the original media is a still (i.e. non-moving) image the representative image is created by scaling the image to fit a predetermined space, where the predetermined space constraint is chosen to facilitate display of multiple search results on a displayed page.

In another embodiment, if the original media is a sequence of images, for example a movie, video, slide show, or changing image, then the representative image is created by selecting one image or frame from the original media and scaling it to fit a predetermined space constraint while maintaining the aspect ratio of the selected image. For example, many video encoding schemes encode a changing image as one or more complete or “key” frames intermingled with a series of difference data as the image changes. In one embodiment, a key frame is selected as a possible representative image that then can be subjected to further filters or tests.

In one embodiment, index server 324 creates a display page that includes a synopsis of each document in index 328 that matches a document query. In one embodiment, if index 328 includes a representative media item for a document matching a query, then the created display page includes a version of the representative media item for that document. In one embodiment, server 324 works in conjunction with media inserter 325 to generate HTML code to produce a display including a synopsis for each document to be listed. The synopsis includes representative text, a representative image if available, and a hyperlink to retrieve the document.

In one embodiment server 324 and media inserter 325 provides the representative image by including a reference to the location of the original image, for example the URL containing the address of the image on the World Wide Web.

In still another embodiment, the source media is processed to produce a smaller and a larger representative image, both of which are stored in index 328. When index server 324 includes the source document in a list of documents matching a query, media inserter 325 builds a display page such that the smaller representative image is shown until the viewer's mouse is moved over the image, causing the larger representative image to appear. This has the advantage of allowing the user to view larger images corresponding to the listed documents by sequentially moving the pointing device or mouse over each image.

In one embodiment, media extractor 327 scans the source document to locate all images or image references. Any images identified are then considered as candidates to become representative of the content of the source document. This process is described in more detail by the flow chart in FIG. 4A. The machine implementation of the media extractor is, in one embodiment, executed by the content section identifier module 139, the media object identifier module 140, and the media object filter/selection module 141 of web crawler application 137 (FIG. 1B).

Several of the following drawings depict methods in the form of flow charts. Each flow chart includes an ordered set of operations and conditions, wherein the test of a condition selects one of two possible paths for subsequent processing. The two paths subsequent to a decision diamond are labeled as “YES” and “NO” in the drawings. In the textual descriptions herein, synonyms for YES are used including true, affirmative, success, and pass. Conversely synonyms for NO include false, negative, and fail.

FIG. 4A is a flow chart of a method for identifying a representative media item in accordance with an illustrative embodiment of the invention. The method presented in FIG. 4A identifies a media content section in a source document. In one embodiment, the source document is a page or document on a web. In one embodiment, the source document is a blog entry retrieved from a weblog site. In one embodiment, the source document is retrieved from the World Wide Web. The source document comprises at least one mixed-media content page (MMCP). The process starts at 401. At 402, the mixed-media content page (MMCP) is downloaded. At 403, the root or domain of the site from which the MMCP was obtained is determined. The root or domain name can be useful in applying logic or processing that corresponds to the source site. The operations described in conjunction with 402 and 403 correspond, in one embodiment, to page access module 138 (FIG. 1B).

One example of using the root or domain name in a useful manner is illustrated at 404. At 404, it is determined if a “parse hint” exists corresponding to the domain identified at 403. A parse hint is information that guides a parser in separation of the content section from other sections of a particular page. The content section contains the media of interest on the downloaded page. For example, the content section can be the text and other media content written by the author of a weblog. Often web pages contain other data that is not of interest in identifying a representative media entry.

In one embodiment, the parse hint extracted at 404 is stored so that it can be retrieved by a subsequent query, wherein the query includes the domain or root part of the URL. For example, the root or domain can indicate the site that served the document. This is useful because many sites have similar formatting for pages served from that site. Thus a parse hint can be stored that is useful for any page downloaded from a particular site, and the site information can be used to retrieve the corresponding parse hint, facilitating parsing of any MMCP from that site.

For example, a parse hint can comprise an Extensible Markup Language (XML) XPath string that describes a method for locating the content section on a page. In one embodiment, the crawler uses this to limit its indexing and parsing to only the content section of a page. This eliminates consideration of most of the page, and in particular eliminates consideration of non-representative images or advertisements on the page when seeking a representative image.

In one embodiment, parse hints are derived from HTML or XHTML tags found on the source page. For example, a blog author or blog site may include one or more parse hints to ensure correct parsing of content. In another embodiment, parse hints are derived from other markup tags on the source page. In one embodiment, the source page is a blog entry that contains HTML or XHTML tags that are used to derive a parse hint. In some embodiments, parse hints are automatically calculated. In other embodiments, parse hints are created by a human being.

Consequently, if a parse hint is identified at decision 404, the parse hint is used at 406 to identify the content section within the MMCP. If no parse hint is identified at 404, parsing is performed using default parsing logic at 405. At 407, it is determined if a content section was successfully identified. If decision 407 is negative, then no media content is identified, and the search terminates at 408.

Typically a content section is successfully identified either at parse 405 or at parse 406, in which case decision 407 is affirmative and the identified content section is available for further processing to locate representative media content. This further processing is performed at 409. The operations described in conjunction with 404-408 correspond, in one embodiment, to content section identifier module 139 (FIG. 1B).

The processing at block 409 is complex and involves many operations. The operations at block 409 are further detailed in FIG. 4B and FIG. 4C, which describe two alternative embodiments with respect to what occurs at 409 in FIG. 4A. In other words FIG. 4B provides further detail of an embodiment of block 409 of FIG. 4A. Similarly, FIG. 4C provides further detail of another embodiment of block 409.

FIG. 4B is a flow chart depicting one embodiment of specific processing according to an illustrative embodiment of the invention. FIG. 4B provides details of the processing at 409 of FIG. 4A in this particular embodiment. Referring to FIG. 4B, the process begins with entry 420. Recall that a content section has been identified and confirmed at 407 (FIG. 4A). At 421, a search is performed to identify media objects in the previously identified content section. In one embodiment, a media object is identified by detection of a hyperlink in the source data for the content section. For example, in an HTML or XHTML source document, each “<img>” or “<embed>” tag in the content section can be used to identify media object references. A content section may contain zero, one or more media objects. In one embodiment all media content is identified. In another embodiment only certain media types are identified. For example it may be desirable to identify images and reject audio files.

The operations described in conjunction with 421-422 correspond, in one embodiment, to media object identifier module 140 (FIG. 1B). The operations described in conjunction with 423-433 correspond, in one embodiment, to media object filter/selection module 141 (FIG. 1B).

Each time a media object is found, the test at 422 is true, and processing of the found media object continues at 423. When no more media objects are found in the content section, the decision at 422 is false, and processing continues at 424. Decision 422 can be false either because there were no media objects in the content or because all of the media objects have been identified and processed.

Continuing now with 423, the identified media object is subjected to a number of tests or filters that apply criteria to determine if the media object is likely to be representative of the content section. It can be appreciated that the content section may contain a variety of media types and that each media type is associated with specific processing and filter criteria. For example, a movie file may be processed by selection of a single representative frame.

A loop is formed by the operations performed at 423, 429, 430, 431, and 433. The loop is entered whenever a media object is identified at decision 422. The loop functions to apply a series of tests to the media object to determine if the object is likely to be representative of the content section. These tests can be referred to by many terms, including filters, media processing, or criteria. The loop is exited either when any test fails at decision 433, or when all tests have completed successfully at decision 429. If the decision at 429 is false, all of the test criteria have been met. In other words when each of the tests has been applied and none has failed, the decision at 429 is negative. The decision at 429 will also be negative in the event there are no filters to apply, or if no filter is available that matches the type of the media object.

If a test fails at 433, the media object is discarded at 432, and the process continues, at 421, searching for the next media object in the content section. If all tests succeed, the decision at 429 will be false, the media object is consequently added to a list at 428, and the process continues, at 421, searching for the next media object.

In one embodiment, if any test fails then the media object is rejected. However, various embodiments comprising complex tests and testing structures are possible, including multiple processes and conditions. In one embodiment, it is only necessary for a predetermined subset of the tests to pass.

Continuing with 423, the filter list is checked to determine which filters are appropriate to the type of the identified media object. If at least one filter is available that has not previously been applied to the media object, decision 429 is affirmative, and processing continues at 430, with selection of a filter. Filters can be selected using various criteria. For example, the filter selection process can operate to apply filters in a predetermined order or sequence. Alternatively, the selection process can select and apply filters in a random sequence. In some embodiments, a filter is selected and applied in a sequence such that filters more likely to fail are applied before filters less likely to fail, saving processing time. In various embodiments, filter selection criteria includes the type of the media object, the source of the content, and various properties of the media object.

The filter selected at 430 is then applied to the media object at 431, and decision 433 determines if the filter operation 431 passed or failed. If the filter 431 passed, processing continues with any remaining filters at 423. If the decision at 433 determines that the test at 431 failed, the image is discarded at 432, and processing continues with seeking the next media object at 421.

It should be appreciated that there are many filters that can be applied, depending on the particular embodiment. It is a feature of various embodiments of the invention that the filtering criteria and processes are not rigidly pre-determined. Accordingly, 423, 429, 430, and 431 describe the application of a list of filters and not a pre-determined set of filtering tests. Thus the filters in the “filter list” of 423 can be changed. For example, in the future, filters can be created and added to the filter list without modifying the structure or implementation of the mechanism or methods described. Similarly, filters can be removed, updated, or modified without modification to the underlying methods or mechanism.

Filters may also be added to the filter list to process differing media types. For example, new media types or filtering techniques will be created in the future, and the filtering list structure described herein can accommodate those without modification to the underlying mechanism.

Several exemplary filtering tests are described, but the list should not be interpreted as being exhaustive or limiting. In one embodiment a filtering test comprises examining the aspect ratio of an image. Representative images are often derived from a photograph or by capturing a still image from a video (sometimes called a “video capture” or “frame grab”). Photographs and video frames frequently exhibit characteristic aspect ratios that correspond to image formats in industry standards or common usage. Conversely, non-representative images such as graphic elements exhibit aspect ratios very distinct from images. For example, representative images are typically roughly square or rectangular while a line is long and thin.

Some common aspect ratios used in television and video recordings are 4:3 and 16:9. Common aspect ratios used in still photography are 4:3, 3:2, and, less commonly 5:4, 6:7, 16:9, and 1:1 (square). Films in movie theaters often use aspect ratios of either 1.85:1 or 2.39:1. Many other defined aspect ratios are used in specialized applications. Representative images often have one of these aspect ratios. However, not all representative images have one of these standard aspect ratios. For example, some images used in blogs have non-standard aspect ratios because they are cropped or edited versions of other images.

In one embodiment a filtering test comprises examining the size of an image. One property of an image is its size or dimensions in both the horizontal and vertical axes. The dimensions can be described in measurement units such as inches or centimeters. Alternatively, the size can be described in terms of number of picture elements or pixels. In another embodiment, the diagonal size of an image is used as a filtering test, measuring between two diagonally opposed corners of the image.

In one embodiment, a test for a representative image is based on the axiom that such an image will have a minimum size in each axis or diagonal. In one embodiment, an image that has a large number of pixels is rejected because it is unlikely to compress well or efficiently to create a representative thumbnail image. In one embodiment, an image that has less than a predetermined number of pixels is rejected. For example, many web pages include single-pixel images that are not representative and these are rejected by a minimum size test. It may be appreciated that a representative image in accordance with various embodiments of the invention is selected by an author, for example, to illustrate a point, enhance his creation, or reinforce a theme. An image selected by an author is thus likely to have a certain minimum size. Tiny images are not typically representative of author-generated content.

In one embodiment a filtering test consists of criteria for the colormap of an image. The colormap criteria determine if the image is likely to represent the content section from which it was extracted. Images can roughly be divided into two-tone or black and white, grayscale, and color images. Thus, an image will contain two or more colors. Some images will also include a clear or transparent color, which allows underlying images to be seen when the image is overlaid on top of other content. The number of colors and the distribution of colors is often indicative of a representative image. For example, a photograph has colors or shades of gray distributed throughout. In contrast, a graphic element often is single-colored or has only a few colors. A line drawing often has many distinct areas of light and dark pixels.

In one embodiment, the colormap itself is tested. Color images are often encoded such that the image data includes a list or map of all the colors used in the image itself. A representative color image will be tested against certain criteria for number of colors. A representative image is also distinct from the background on which it is displayed.

In one embodiment, the image colors are compared with the color of the background and the image is rejected if the image colors are not distinct from the background. Web pages often include hidden images, wherein these images are hidden by making them the same color as the background. Thus the images are rendered and displayed by a browser but are not visible to a user. This test rejects hidden or invisible images because they are not representative.

In one embodiment, the filtering of media objects includes reference to a list of known media objects that have previously been determined not to be representative. Such an exclusion list is also referred to as a “blacklist,” and inclusion of an object or an object location on the list is termed “blacklisting.” In one embodiment the exclusion list contains URLs pointing to excluded objects.

In another embodiment, the exclusion list contains partial location data and expressions that will match multiple objects, sometimes called wildcards. One representation of a partial location is known as a regular expression. For example, all of the objects on a given server or site can be blacklisted. In one embodiment the blacklist comprises sub-lists corresponding to different entities. For example, in various embodiments, a unique blacklist is maintained for each specific weblog author, for each blog website, or for each provider.

In another embodiment, the blacklist entry for an item is derived from processing the media object itself. For example, a media object can be characterized by a process that yields a unique or nearly unique value suitable for easy storage and retrieval. For example, the unique value can be a title, a computed signature, a hash value, or other characteristic that reliably identifies an object.

The outcome of the processing described in this embodiment is a list containing all media objects in the content section that passed all tests applied. When all media objects have been added to the list, processing continues with decision 424. Since it is possible that a content section has no media objects that meet the test criteria, test 424 determines if the list is empty. If test 424 is affirmative, no further processing can be performed, and the process terminates at 427.

If decision 424 is negative, the media object list is not empty, and processing continues to 425. At 425, one object is selected from the objects in the list to represent the content section. There are multiple ways the selection 425 can be performed, depending on the particular embodiment. In one embodiment, the first item in the list is selected.

In one embodiment of the selection at 425, one of the items in the list is selected arbitrarily or using a random or pseudo-random number generator. In another embodiment, each item in the list has an associated quality score, where the quality score is a quantitative result of operations performed in the testing or filtering of the item at 431. The item with the highest quality score is then selected as representative at 425.

At 426, information about the selected representative media item is stored. The information stored can include any data that will facilitate later retrieval and rendering of the media item. For example, the stored data can include, without limitation, the item data, a description of the item, an item locator, a URL, metadata related to the item, and the size of the item.

In the filtering tests employed by various embodiments of the invention, an important distinction is made. Some of the tests can be performed on media metadata or links to media files found in the document source. By contrast, other tests download the media and examine the media object data. Some tests also partially or completely render or otherwise process the media object data to facilitate the test. Accordingly, each test will use either the media object metadata or the downloaded data, as appropriate.

In some filter tests, it is possible that the distinction between using metadata and downloading the media object cannot be predetermined. For example, image size data is used in many tests. Image size data is sometimes available in source document metadata, but not always. The link to the image may include the image size. For example, an HTML “<IMG>” tag sometimes contains an image size attribute.

When the image size is available in the source document metadata, it is more efficient to use that data rather than download the image. However, if the source document does not contain the image dimensions, the image is downloaded to obtain the size data for the test. Thus, it is desirable to use the data in the source document metadata for filter testing whenever possible because downloading a media object consumes processing time and memory. However, once a media object has been downloaded for a filter test, the object can be saved for further testing and subsequent filters.

FIG. 4C is a flow chart depicting another embodiment of specific processing according to an illustrative embodiment of the invention. Turning now to FIG. 4C, another embodiment of the processing at block 409 of FIG. 4A is described in detail. The processing begins at entry 440 and proceeds at 441 with a search in the content area for a media item. Recall that the content area was previously identified at either 405 or 406 in FIG. 4A.

Those skilled in the art will recognize the controlling structure in FIG. 4C as two nested loops. The outer loop iterates through each media item or object in the content area. The inner loop applies a series of tests or filters to each media item, iterating through the list of tests. The inner loop exits when all of the tests have passed for an object, indicating that the object is representative. In this embodiment, the first media item that passes all tests is selected, even though other media items may remain. In other embodiments, all of the media items in the content area meeting the test criteria are considered before selecting any item as representative. The inner loop also exits when any test fails for an object.

The operations described in conjunction with 441-442 correspond, in one embodiment, to media object identifier module 140 (FIG. 1B). The operations described in conjunction with 443-449 correspond, in one embodiment, to media object filter/selection module 141 (FIG. 1B).

A salient feature of the embodiment described in FIG. 4C is that the tests to be performed are taken from a list structure rather than being rigid and predefined. Thus, the particular tests to be performed or the order of their performance can be modified, depending on the particular embodiment, without change to the underlying methods or mechanism. The test list structure in conjunction with the test selection 443 also provides that the tests applied can be based on the type or other properties of the media item being tested. In addition, the number of filters, types of tests, and the types of media items that can be tested are not in any way limited, but can be altered without affecting the underlying principles of the invention.

The outer loop structure of FIG. 4C begins at 441 by searching the content area to determine if any media items remain for consideration. At decision 442, this determination is made. If a media item is found, the inner loop commences with test selection at 443. At 443, a list of tests or filters appropriate for the media object identified at 441 is considered, and one test to perform is selected. The selected test is executed at 445, and the results evaluated at decision 446. If the test fails, the media item is discarded (at 444), and the search for another media item continues at 441.

If the decision at 446 indicates that the test passed, processing continues with the decision at 447, which determines if all the tests appropriate for the media item have been performed. If the decision at 447 is negative, then no more tests remain, and all tests for the media object under test have succeeded. In one embodiment, when all tests for a media object have succeeded, the object is judged to be representative.

If the decision at 447 is affirmative, more tests remain for the media item, and testing continues with selection of another test at 443.

In various embodiments, the testing performed in filtering media objects may include many methods and processes. By way of example, if the media item is an image, the tests may include, without limitation, examination of the item's size, aspect ratio, color depth, colormap, color distribution, contrast with background color, or a combination or sub-combination thereof. These tests may use metadata from the source document or include downloading, processing, and rendering of the media item. Some exemplary tests are described in conjunction with FIG. 4B. Those tests are applicable to other embodiments, including the embodiment depicted in FIG. 4C.

When a media item is determined to be representative at 447, it is stored at 448. In one embodiment, storage operation 448 includes storing the location of the media item rather than the item data. For example, when an image appears on a web, storing the URL or a hyperlink reference to the image is preferable to storage of the image itself. In another embodiment the item data is stored. In various embodiments, the item data is recorded in original, compressed, or thumbnail form. This can be preferable when generation of the representative image is complex or time-consuming. One example is the extraction of a still image from a movie. After storage, the process is complete and stops at 450. In one embodiment, metadata describing the media item is stored in association with the media item or media item location. In one embodiment, the media item is an image and the metadata contains the dimensions of the image.

If the decision at 442 is negative, no representative images were identified in the content section. In one embodiment the lack of a representative image is noted and stored at 449. After the negative decision at 442, processing terminates at 450.

FIG. 5 is a flow chart of a method for testing a media object in accordance with an illustrative embodiment of the invention. In particular, FIG. 5 illustrates an embodiment including a filter that tests the size of a media item. The testing of a media item shown in FIG. 5 corresponds, in various embodiments, to one of the tests that may be performed at 431 (FIG. 4B) and 445 (FIG. 4C). The machine implementation of this test, in one embodiment, corresponds to the media object filter/selection module 141 (FIG. 1B).

In the embodiment illustrated in FIG. 5, the test begins by considering markup tags in a source document, wherein the markup tags are associated with a particular media item of interest. The markup tags are parsed at 501, yielding the contents of the tags. For example, the markup tags may contain size data descriptive of the media item, and in some embodiments size data is used in determining if the item is representative.

At decision 502 it is determined if size data is present in the data from the markup tags. In one embodiment the size data is subjected to additional testing to determine if it is reasonable and appears valid. If the decision at 502 is true, further processes at 506 determine the horizontal and vertical dimensions of the media item of interest using the data from the tags. This alternative illustrates the determination of various properties of an image without actually downloading the image. For example, image size data can sometimes be obtained from metadata or in markup tags.

Alternatively, if the decision at 502 is that no useful image size data can be obtained from the source document metadata, or that the image size data in the source document is not valid, the process continues at 503. At 503, the image data is downloaded. At 504, the image is rendered, and the size data is extracted from the fully or partially rendered image at 505. In another embodiment, the size of the image is determined by direct examination of the downloaded image data, without performing a rendering operation.

Then, at 507, a decision is made to determine if the image size data indicates that the image is a representative image. Criteria applied to make this decision may, in various embodiments, include minimum or maximum size in each of the two image axes, maximum or minimum size along the image diagonal, or acceptable bounds on the ratio of the horizontal dimension to the vertical dimension. In some embodiments, the area of the image can be compared against defined criteria as part of the determination of whether the image is representative. If the decision at 507 is affirmative, then the image size is acceptable, and the filter test passes at 508 indicating that the image is representative. If the decision at 507 is negative, the filter test fails at 509, indicating that the image is not representative.

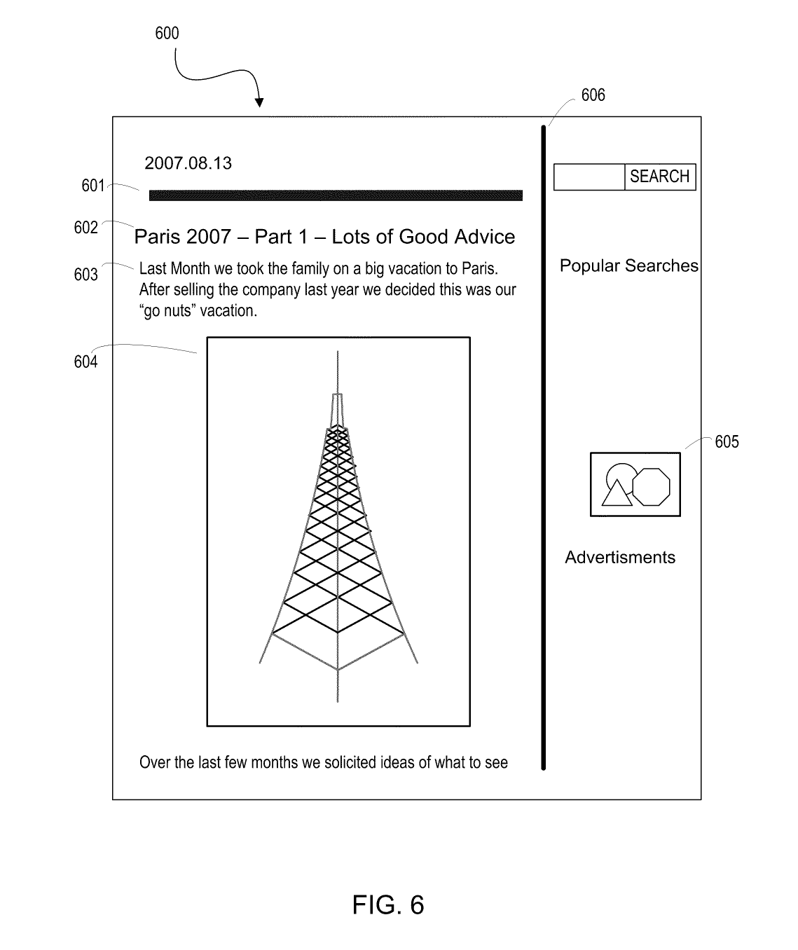

FIG. 6 schematically depicts a displayed page corresponding to a source document that is to be indexed in accordance with an illustrative embodiment of the invention. The display 600 is a line drawing representing a screen captured from a weblog. In various embodiments of the invention, it is desired to identify a graphical element to use as a representative synopsis of this page. Text elements 602 and 603 are identified as media in the content area, but are not graphical. Four graphical elements 601, 604, 605, and 606 are identified. Element 601, although it appears first in the document, is not representative. Graphical element 601 is a formatting device and does not meet the criteria for representative content. Similarly, element 606 is a graphical element and not representative. In one embodiment, both elements 601 and 606 are rejected by an aspect ratio, contrast, or color map test. Graphical element 605 is outside the content area and thus is determined to not be representative of the content.

Graphic element 604 is a representative element. In one embodiment, element 604 is selected as representative based on at least one of: its location on the page, its size, its aspect ratio, its number of brightness levels, its contrast distribution between lightness and darkness, and its difference in color from the page background. Each of these characteristics distinguishes representative image element 604 from non-representative image elements 601, 606, and 605.

Thus image 604 is selected as representative and processed to include a thumbnail image in a subsequent search-results listing. An illustration of the use of the thumbnail image is shown in FIG. 7.

Refer next to FIG. 7, which schematically depicts a web page search result 700 in accordance with an illustrative embodiment of the invention. In the display page depicted in FIG. 7, three documents have been identified as matching a search query, and a synopsis is shown for each of the three. Document synopsis one comprises elements 701-704. Document synopsis two comprises elements 705-707. Document synopsis three comprises elements 708-711.

Document synopsis one contains a title element 703, a text summary element 702 and a graphical synopsis thumbnail 701, and a hyperlink to the document 704. This document corresponds to the display document 600 in FIG. 6, and image thumbnail 701 has been generated as a synopsis, using image 604 in FIG. 6 by applying techniques such as those described above.

Document synopsis two contains a title 705, a text summary 706, and a hyperlink to the document 707. Document synopsis two does not contain an image because the source document did not contain a representative image or because a representative media element was not identified.

Document synopsis three contains a thumbnail image 708, title 709, text summary 710 and hyperlink 711, similar to document synopsis one.

FIG. 8A is a schematic depiction of the functional elements involved in responding to a search query according to an embodiment of the invention. FIG. 8A is divided into two sections. The client side is shown as client 801, and the server side is shown as server 802. Server 802 comprises functional blocks application server 803, search server 805, and code generator 807. Server 802 also contains database 804 and document index 806.

The component parts of server 802 are schematic depictions of functional elements and do not illustrate any particular assignment of functional elements to physical computing hardware. In one embodiment, all of the functions are performed by a single server or hardware unit. In one embodiment the functions are performed by a cluster of networked computers. In another embodiment, the functions of server 802 are divided into two tiers, wherein the application tier comprises application server 803, database 804, and code generator 807 and the search tier comprises search server 805 and index 806. In one embodiment, each functional tier is assigned to a server.

One illustrative embodiment of a machine implementation of the functional blocks illustrated in FIG. 8A is shown in FIG. 1C. Application server 803 is implemented as instructions in search page generator module 158 and social network query module 160. Module 158, when executed, generates a display page wherein a user can enter and transmit a search query and the query is performed by the instructions in social network query module 160, which operates to access a network of trust and informer data in database 804. As described, database 804 is implemented, in various embodiments, as one or more persistent storage devices in memory 156 (FIG. 1C) or accessed through network communications using communications interface 155.

Continuing with the illustrative embodiment of the machine implementation in FIG. 1C of the functions in FIG. 8A, the function of search server 805 is performed by execution of the instructions in document index query module 159, which operates to access data in index 806. As described, index 806 is implemented, in various embodiments, as one or more persistent storage devices in memory 156 (FIG. 1C) or accessed through network communications using communications interface 155. The function of code generator 807 is performed by execution of instructions in result page generator module 161, which operates to create a file containing machine-readable code and return the file to browser 801. Communications between client/browser 801 and server 802 are implemented as instructions in the various modules in server application 156 that operate to cause communication to be sent and received via data bus 151 and communications interface 155.

In one embodiment, a search query is received by application server 803 from client 801, causing application server 803 to obtain information from database 804. In one embodiment, the information obtained by application server 803 from database 804 is stored in a cache. When data is stored in a cache, subsequent requests for the data will not trigger interaction with database 804. In one embodiment, application server 803 maintains fresh data by storing data in a cache for a predetermined time period before deleting it.

Application server 803 obtains informer network data corresponding to social network links from database 804. Application server 803 then forwards the search query, including the information from database 804, to search server 805. Search server 805 matches the query against document index 806 and obtains an ordered list of search results. In one embodiment the search results are an ordered list of weblog entries with media excerpts. In one embodiment, the search results include an image URL and image size data for each search result that has an associated representative media item.

In one embodiment, the search results are then forwarded to code generator 807. Code Generator 807 generates a source document (or page) containing code that will produce a desired search display on browser/client 801. The code generator, in various implementations, generates the source document using coding and languages suitable for compatibility with browsers. Examples of the code that may be included in the source page include HTML, JAVA, JAVASCRIPT, and XML. In some embodiments, code generator 807 receives unformatted XML code and applies formatting to generate the source document.

It should be appreciated that code generator 807, in various embodiments, is included as a component in other modules. For example, code generator 807 may be implemented within application server 803. The functions of code generator 807, in some embodiments, are divided among various modules. For example, partially or fully generated code may be obtained from 804 or 806.

The generated source document is returned to browser 801, wherein the code is executed to produce a display document. In one embodiment, the desired search display contains thumbnail images corresponding to the excerpts from representative media objects. In this embodiment, the HTML and JAVASCRIPT are generated in code generator 807 such that when executed in browser 801 they operate to cause browser 801 to retrieve the image referenced by the URL, retrieve the image data, and then to scale image down to a thumbnail size for display, preserving the original image aspect ratio.

FIG. 8B is a schematic depiction of the functional elements involved in responding to a search query according to another embodiment of the invention. FIG. 8B is divided into two primary groups. The client side is shown as client 851, and the server side is shown as server 852. Server 852 comprises functional blocks frontend server 853, backend server 855, database 854, and index 856.

In one embodiment, a search query is received by frontend server 853 from client 851, causing server 853 to obtain information from database 854. Server 853 obtains informer network data corresponding to social network links from database 854. Frontend server 853 then forwards the search query, including the information from database 854, to backend server 855. Server 855 matches the query against document index 856 to obtain an ordered list of matching document references. In one embodiment the search results are an ordered list of weblog entries with media excerpt references. In one embodiment, the search results include an image URL and image size data for each search result that has an associated representative media item.

The ordered list of document references and image references is then returned to code frontend server 853. Server 853 generates HTML and JAVASCRIPT code that will produce a desired search display on browser/client 851. In one embodiment, the search display contains an excerpt from each document reference and a thumbnail image corresponding to each associated image reference. In this embodiment, the HTML and JAVASCRIPT are generated to operate in browser 851 to cause browser 851 to retrieve the image referenced by the URL and then to scale the image down to a thumbnail size for display, while preserving the original image aspect ratio.

In conclusion, the present invention provides, among other things, a method and system for identifying and extracting a representative media item from an online document and processing the media item for use in a synopsis of the document. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

What is claimed is:

1. A system for identifying a representative image in an electronic document, the system comprising:
at least one processor; and
a memory connected with the at least one processor, the memory containing a plurality of program instructions configured to cause the at least one processor to:
identify a content section in the electronic document;
identify one or more media items referenced or contained in the content section;
identify, among the one or more media items, at least one image that satisfies one or more predetermined criteria applied during an analysis pertaining to the one or more media items;
select, from among the at least one image that satisfies the one or more predetermined criteria, a particular image as the representative image; and
store information about the representative image.

2. The system of claim 1, wherein the plurality of program instructions are configured to cause the at least one processor to:
identify all images referenced or contained in the content section; and
consider all of the identified images in identifying, among the one or more media items, at least one image that satisfies one or more predetermined criteria.

3. The system of claim 2, wherein the plurality of program instructions are configured to cause the at least one processor to:
assign a quality score to each identified image, the quality score of each image measuring how well that image satisfies the one or more predetermined criteria;
select, as the representative image, an image having the best quality score.

4. The system of claim 2, wherein the plurality of program instructions are configured to cause the at least one processor, when each of a plurality of the identified images satisfies the one or more predetermined criteria, to select randomly the particular image as the representative image.

5. The system of claim 1, wherein the plurality of program instructions are configured to cause the at least one processor to select, as the representative image, the first image encountered in the content section that satisfies the one or more predetermined criteria.

6. The system of claim 1, wherein the plurality of program instructions are configured to cause the at least one processor, during the analysis, to:
ascertain what type of media item each identified media item is; and
accept, for further analysis, only certain predetermined types of media items.

7. The system of claim 6, wherein the one or more predetermined criteria applied to a media item depend on the type of that media item and wherein the type is one of a still image, a moving image, a slide presentation, and an audio file.

8. The system of claim 6, wherein the certain predetermined types of media items are visual media items and wherein each visual media item is one of a still image, a moving image, and a slide show.

9. The system of claim 1, wherein the plurality of program instructions are further configured to cause the at least one processor to:
download and render an identified media item referenced in the content section; and
apply the one or more predetermined criteria to properties of the downloaded and rendered identified media item.

10. The system of claim 1, wherein the plurality of program instructions are configured to cause the at least one processor, during the analysis, to compare one of an identified media item and its Uniform Resource Locator (URL) with a list of known media items that have been previously determined to be non-representative.

11. The system of claim 1, wherein the plurality of program instructions are configured to cause the at least one processor, during the analysis, to analyze the size of a visual media item and wherein the one or more predetermined criteria include at least one of a minimum and a maximum size in at least one of a horizontal, a vertical, and a diagonal direction.

12. The system of claim 1, wherein the plurality of program instructions are configured to cause the at least one processor, during the analysis, to analyze the aspect ratio of a visual media item.

13. The system of claim 12, wherein the plurality of program instructions are configured to cause the at least one processor, during the analysis, to compare the aspect ratio of a visual media item with at least one of a set of predetermined aspect ratios associated with representative visual media items and a set of predetermined aspect ratios associated with non-representative visual media items.

14. The system of claim 1, wherein the plurality of program instructions are configured to cause the at least one processor, during the analysis, to analyze colors in an image and wherein the one or more predetermined criteria include at least one of the number of colors, the variety of colors, the presence of certain colors, the absence of certain colors, and a comparison between an image color and a background color.

15. The system of claim 1, wherein the plurality of program instructions are configured to cause the at least one processor, during the analysis, to apply a plurality of tests to an identified media item, each test having an associated set of predetermined criteria.

16. The system of claim 15, wherein the plurality of tests include tests for media-item type, color, size, and aspect ratio and wherein the plurality of program instructions are configured to cause the at least one processor to combine the results of the plurality of tests.

17. The system of claim 15, wherein the plurality of program instructions are configured to cause the at least one processor to:
generate a score for each test; and
combine the scores from the plurality of tests to produce an aggregate quality score for the identified media item.

18. The system of claim 1, wherein the plurality of program instructions are configured to cause the at least one processor to:
select, as the representative image, a particular image frame from a media item made up of a plurality of image frames;
store the particular image frame; and
create and store a Uniform Resource Locator (URL) corresponding to the stored particular image frame.

19. The system of claim 18, wherein the media item made up of a plurality of image frames is a video clip and wherein the particular image frame is a key frame.

20. The system of claim 1, wherein the electronic document is available via the World Wide Web.

21. The system of claim 1, wherein the content section includes a weblog entry and wherein the representative image is associated with the weblog entry.

22. The system of claim 1, wherein the information about the representative image includes at least one of a Uniform Resource Locator (URL) corresponding to the representative image and metadata regarding properties of the representative image and wherein the plurality of program instructions are further configured to cause the at least one processor to transmit to a browser application running on a client computer a synopsis of the electronic document in response to a search query, the synopsis including the URL corresponding to the representative image.

23. The system of claim 22, wherein the plurality of program instructions are configured to cause the at least one processor to transmit to the client computer, along with the synopsis, instructions that cause the browser application to scale the representative image to a predetermined size when the synopsis including the representative image is rendered as an item in a list of search results.

24. The system of claim 22, wherein the plurality of program instructions are configured to cause the at least one processor to transmit to the client computer, along with the synopsis, instructions that cause the representative image to be hyperlinked to the electronic document when the synopsis including the representative image is rendered as an item in a list of search results.

25. The system of claim 22, wherein the synopsis includes information about the electronic document derived from a social trust network.

26. A system for identifying a representative image in an electronic document, the system comprising:
at least one processor; and
a memory connected with the at least one processor, the memory containing a plurality of program instructions configured to cause the at least one processor to:
parse the electronic document to identify a content section;
parse the content section to identify one or more media items referenced or contained in the content section;
analyze at least one of information about the one or more media items and the one or more media items to identify, among the one or more media items, a plurality of images;
apply one or more predetermined criteria to each image in the plurality of images, the one or more predetermined criteria concerning at least one of image color content, size, and aspect ratio;
select, from among one or more images in the plurality of images that satisfy the one or more predetermined criteria, a particular image as the representative image;
store information about the representative image, the information about the representative image including at least one of a Uniform Resource Locator (URL) corresponding to the representative image and metadata regarding properties of the representative image; and
transmit to a browser application running on a client computer a synopsis of the electronic document in response to a search query, the synopsis including the URL corresponding to the representative image.

27. A system for identifying a representative image in an electronic document, the system comprising:
at least one processor; and
a memory connected with the at least one processor, the memory containing a plurality of program instructions configured to cause the at least one processor to:
parse the electronic document to identify a content section;
parse the content section to identify one or more media items referenced or contained in the content section;
determine, as each media item is encountered, whether that media item includes an image;
apply one or more predetermined criteria to each image found among the one or more media items until an image is found that satisfies the one or more predetermined criteria, the one or more predetermined criteria concerning at least one of image color content, size, and aspect ratio;
select, as the representative image, the image that satisfies the one or more predetermined criteria;
store information about the representative image, the information about the representative image including at least one of a Uniform Resource Locator (URL) corresponding to the representative image and metadata regarding properties of the representative image; and
transmit to a browser application running on a client computer a synopsis of the electronic document in response to a search query, the synopsis including the URL corresponding to the representative image.

28. A computer-server-based method for identifying a representative image in an electronic document, the computer-server-based method comprising:
identifying, via the computer server, a content section in the electronic document;
identifying, via the computer server, one or more media items referenced or contained in the content section;
identifying, via the computer server among the one or more media items, at least one image that satisfies one or more predetermined criteria applied during an analysis pertaining to the one or more media items;
selecting, via the computer server from among the at least one image that satisfies the one or more predetermined criteria, a particular image as the representative image; and
storing, via the computer server, information about the representative image.

29. The computer-server-based method of claim 28, wherein all images referenced or contained in the content section are identified and wherein the identifying, among the one or more media items, at least one image that satisfies one or more predetermined criteria includes consideration of all of the identified images.

30. The computer-server-based method of claim 29, wherein the analysis includes:
assigning a quality score to each identified image, the quality score of each image measuring how well that image satisfies the one or more predetermined criteria;
selecting, as the representative image, an image having the best quality score.

31. The computer-server-based method of claim 29, wherein, when each of a plurality of the identified images satisfies the one or more predetermined criteria, the particular image is selected randomly as the representative image.

32. The computer-server-based method of claim 28, wherein the first image encountered in the content section that satisfies the one or more predetermined criteria is selected as the representative image.

33. A computer-server-based method for identifying a representative image in an electronic document, the computer-server-based method comprising:
parsing the electronic document via the computer server to identify a content section;
parsing the content section via the computer server to identify one or more media items referenced or contained in the content section;
analyzing, via the computer server, at least one of information about the one or more media items and the one or more media items to identify, among the one or more media items, a plurality of images;
applying, via the computer server, one or more predetermined criteria to each image in the plurality of images, the one or more predetermined criteria concerning at least one of image color content, size, and aspect ratio;
selecting, via the computer server from among one or more images in the plurality of images that satisfy the one or more predetermined criteria, a particular image as the representative image;
storing, via the computer server, information about the representative image, the information about the representative image including at least one of a Uniform Resource Locator (URL) corresponding to the representative image and metadata regarding properties of the representative image; and
transmitting from the computer server to a browser application running on a client computer a synopsis of the electronic document in response to a search query, the synopsis including the URL corresponding to the representative image.

34. A computer-server-based method for identifying a representative image in an electronic document, the computer-server-based method comprising:
parsing the electronic document via the computer server to identify a content section;
parsing the content section via the computer server to identify one or more media items referenced or contained in the content section;
determining, via the computer server as each media item is encountered, whether that media item includes an image;
applying, via the computer server, one or more predetermined criteria to each image found among the one or more media items until an image is found that satisfies the one or more predetermined criteria, the one or more predetermined criteria concerning at least one of image color content, size, and aspect ratio;
selecting, via the computer server as the representative image, the image that satisfies the one or more predetermined criteria;
storing, via the computer server, information about the representative image, the information about the representative image including at least one of a Uniform Resource Locator (URL) corresponding to the representative image and metadata regarding properties of the representative image; and
transmitting from the computer server to a browser application running on a client computer a synopsis of the electronic document in response to a search query, the synopsis including the URL corresponding to the representative image.
